(19) United States
(12) Patent Application Publication
(10) Pub. No.: US 2026/0073538 A1
(43) Pub. Date: Mar. 12, 2026

(54) SEMANTICALLY-GUIDED PLANAR THREE DIMENSIONAL (3D) RECONSTRUCTION

(71) Applicant: QUALCOMM Incorporated, San Diego, CA (US)

(72) Inventors: Oleksandr BAILO, Amsterdam (NL); Mohsen GHAFOORIAN, Diemen (NL); Jihong JU, Amsterdam (NL); Georgi DIKOV, Amsterdam (NL)

(21) Appl. No.: 18/883,827

(22) Filed: Sep. 12, 2024

(51) Int. Cl. G06T 7/50; G06T 7/12; G06T 7/80

(52) U.S. Cl. CPC G06T 7/50; G06T 7/12; G06T 7/80

(57) ABSTRACT

Systems and techniques are described for image processing. For example, a computing device can generate, based on a first depth map corresponding to a scene and a first semantic segmentation map of the scene, first blocks associated with a planar surface within the scene. The computing device can determine, based on the first blocks, a representation of the planar surface. The computing device can replace, based on the representation of the planar surface, first depths for pixels associated with the planar surface in the first depth map with second depths for the pixels associated with the planar surface from a prior depth map corresponding to the scene to generate an updated depth map corresponding to the scene. The computing device can generate, based on the updated depth map and the first semantic segmentation map, second blocks associated with the planar surface within the scene.

### FIELD

The present disclosure generally relates to image processing. For example, aspects of the present disclosure relate to semantically-guided planar three dimensional (3D) reconstruction.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

In recent decades, there has been a demand for 3D content for computer graphics, virtual reality, and communications. In order to reconstruct a 3D scene of an environment, multiple image frames of the environment need to be captured by an image-capturing device (e.g., including a camera device), such as an extended reality (XR) head-mounted device (e.g., glasses) or a mobile phone. However, a thorough scanning of the environment is a challenging process that can often result in unwanted artifacts in the reconstruction.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for image processing. In some aspects, an apparatus for image processing is provided. The apparatus includes at least one memory and at least one processor coupled to the at least one memory and configured to: generate, based on a first depth map corresponding to a scene and a first semantic segmentation map of the scene, a plurality of first blocks associated with a planar surface within the scene; determine, based on the plurality of first blocks, a representation of the planar surface; replace, based on the representation of the planar surface, first depths for pixels associated with the planar surface in the first depth map with second depths for the pixels associated with the planar surface from a prior depth map corresponding to the scene to generate an updated depth map corresponding to the scene; and generate, based on the updated depth map corresponding to the scene and the first semantic segmentation map of the scene, a plurality of second blocks associated with the planar surface within the scene.

In some aspects, a method for image processing is provided. The method includes: generating, based on a first depth map corresponding to a scene and a first semantic segmentation map of the scene, a plurality of first blocks associated with a planar surface within the scene; determining, based on the plurality of first blocks, a representation of the planar surface; replacing, based on the representation of the planar surface, first depths for pixels associated with the planar surface in the first depth map with second depths for the pixels associated with the planar surface from a prior depth map corresponding to the scene to generate an updated depth map corresponding to the scene; and generating, based on the updated depth map corresponding to the scene and the first semantic segmentation map of the scene, a plurality of second blocks associated with the planar surface within the scene.

In some aspects, a non-transitory computer-readable medium is provided having stored thereon instructions that, when executed by at least one processor, cause the at least one processor to: generate, based on a first depth map corresponding to a scene and a first semantic segmentation map of the scene, a plurality of first blocks associated with a planar surface within the scene; determine, based on the plurality of first blocks, a representation of the planar surface; replace, based on the representation of the planar surface, first depths for pixels associated with the planar surface in the first depth map with second depths for the pixels associated with the planar surface from a prior depth map corresponding to the scene to generate an updated depth map corresponding to the scene; and generate, based on the updated depth map corresponding to the scene and the first semantic segmentation map of the scene, a plurality of second blocks associated with the planar surface within the scene.

In some aspects, an apparatus for image processing is provided. The apparatus includes: means for generating, based on a first depth map corresponding to a scene and a first semantic segmentation map of the scene, a plurality of first blocks associated with a planar surface within the scene; means for determining, based on the plurality of first blocks, a representation of the planar surface; means for replacing, based on the representation of the planar surface, first depths for pixels associated with the planar surface in the first depth map with second depths for the pixels associated with the planar surface from a prior depth map corresponding to the scene to generate an updated depth map corresponding to the scene; and means for generating, based on the updated depth map corresponding to the scene and the first semantic segmentation map of the scene, a plurality of second blocks associated with the planar surface within the scene.

In some aspects, one or more of the apparatuses described herein is, can be part of, or can include an extended reality (XR) device (e.g., a virtual reality (VR) device, an augmented reality (AR) device, or a mixed reality (MR) device), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a vehicle (or a computing device, system, or component of a vehicle), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example device that may employ a color metadata buffer for 3D reconstruction, in accordance with some aspects of the disclosure.

FIG. 2 is a diagram illustrating an example of a 3D surface reconstruction of a scene modeled as a volume grid, in accordance with some aspects of the disclosure.

FIG. 3 is a diagram illustrating an example of a hash mapping function for indexing blocks (e.g., voxel blocks) in a volume grid, in accordance with some aspects of the disclosure.

FIG. 4 is a diagram illustrating an example of a block (e.g., a voxel block), in accordance with some aspects of the disclosure.

FIG. 5 is a diagram illustrating an example of a truncated signed distance function (TSDF) volume reconstruction, in accordance with some aspects of the disclosure.

FIG. 6 is a diagram illustrating an example of a voxel block selection algorithm, in accordance with some aspects of the disclosure.

FIG. 7A is a block diagram illustrating a computer vision (CV) 3D reconstruction (3DR) engine, in accordance with some aspects of the disclosure.

FIG. 7B is an example of a volume block, in accordance with some aspects of the disclosure.

FIG. 8 is a diagram illustrating an example of a 3D reconstruction of a scene using a depth map generated by machine learning, in accordance with some aspects of the disclosure.

FIG. 9 is a diagram illustrating an example of a 3D reconstruction of a scene using a depth map generated by a time of flight (TOF) sensor, in accordance with some aspects of the disclosure.

FIG. 10 is a diagram illustrating an example of a process to improve the planarity and completeness of a planar surface, in accordance with some aspects of the disclosure.

FIG. 11 is a diagram illustrating an example of a process that incorporates planar constraints to improve the quality of a 3D reconstruction of a scene, in accordance with some aspects of the disclosure.

FIG. 12 is a flow diagram illustrating an example of a process for image processing, in accordance with some aspects of the disclosure.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, in recent decades, there has been a demand for 3D content for computer graphics, virtual reality, and communications. In order to reconstruct a 3D scene of an environment, multiple image frames of the environment need to be captured by an image-capturing device (e.g., including an image sensor), for example an XR head-mounted device (e.g., glasses) or a mobile phone. However, a thorough scanning of the environment can be a challenging process that can often result in unwanted artifacts in the reconstruction. These artifacts can include constructing non-planar surfaces, which are naturally planar in reality (e.g., a floor), due to noise in the reconstruction data (e.g., including depth, sensor data, sensor pose, and/or sensor calibration parameters). These artifacts can also include constructing holes in planar structures, which do not have holes in reality, due to missing geometry (e.g., incomplete depth data). For example, time of flight (TOF) sensors, used to obtain depth data, often do not perform well on reflective or dark surfaces and, as such, can produce sparse depth data. Accurate and complete planar geometry is extremely important to facilitate an immersive experience for a user of XR. Accurate and complete planar geometry can facilitate realistic virtual object placement and can prevent the possibility of a virtual object falling through a hole in a scene resulting from sparse depth data.

As such, improved systems and techniques for providing accurate and complete planar geometry can be beneficial.

In one or more aspects of the present disclosure, systems, apparatuses, methods (also referred to as processes), and computer-readable media (collectively referred to herein as “systems and techniques”) are described herein that provide solutions for semantically-guided planar 3D reconstruction.

Various aspects relate generally to image processing. Some aspects more specifically relate to systems and techniques that provide solutions that incorporate efficient semantically-driven planar constraints to improve the quality of a 3D reconstruction. The systems and techniques leverage existing semantic information to refine input depth data before performing the 3D reconstruction. Smoothing out of a planar surface occurs on a TSDF volume, instead of on a mesh. The systems and techniques provide an algorithm that first integrates N number of frames without planar constraints to obtain a semantic TSDF volume. Once a surface plane (e.g., a planar prior, which is a prior depth map for a planar surface) is estimated, the virtual plane can be projected to a camera view of a depth sensor to modify depth readings from the depth sensor. The refined depth can then be integrated into the 3D reconstructed model.

In one or more examples, the systems and techniques provide mechanisms to mitigate failure cases. These mechanisms to mitigate failure cases include detecting a significant difference between a planar prior and a depth observation and using uncertainty-based filtering of a semantic prior (e.g., a prior semantic segmentation map).

In one or more aspects, during operation of a method for image processing, one or more processors of a device can generate, based on a first depth map corresponding to a scene and a first semantic segmentation map of the scene, a plurality of first blocks associated with a planar surface within the scene. The one or more processors can determine, based on the plurality of first blocks, a representation of the planar surface. The one or more processors can replace, based on the representation of the planar surface, first depths for pixels associated with the planar surface in the first depth map with second depths for the pixels associated with the planar surface from a prior depth map corresponding to the scene to generate an updated depth map corresponding to the scene. The one or more processors can generate, based on the updated depth map corresponding to the scene and the first semantic segmentation map of the scene, a plurality of second blocks associated with the planar surface within the scene.

In one or more examples, the one or more processors can further generate, based on a plurality of depth maps corresponding to the scene and a plurality of second semantic segmentation maps of the scene, a plurality of third blocks associated with the planar surface within the scene. In some examples, the one or more processors can further determine, based on an area of the planar surface covered by the plurality of third blocks being greater than an area threshold value, the prior depth map based on the plurality of depth maps. In one or more examples, replacing the first depths for the pixels associated with the planar surface in the first depth map with the second depths for the pixels associated with the planar surface from the prior depth map can be further based on a difference in the first depths and the second depths being less than a depth threshold value.

In some examples, a sensor can generate the first depth map corresponding to the scene. In one or more examples, the sensor can be a time of flight (TOF) sensor or an image sensor. In other examples, the sensor can be a light detection and ranging (LIDAR) sensor or a radio detection and ranging (RADAR) sensor. In some examples, generating the plurality of first blocks associated with the planar surface within the scene can be further based on a pose of the sensor and intrinsic parameters of the sensor, and wherein generating the plurality of second blocks associated with the planar surface within the scene can be further based on the pose of the sensor and the intrinsic parameters of the sensor. In one or more examples, each block of the plurality of first blocks can be a voxel. In some examples, the voxel can be a semantic truncated signed distance function (TSDF) volume. In one or more examples, the planar surface can be a floor, a wall, or a ceiling. In some examples, the representation of the planar surface can be a surface plane equation representing the planar surface as a normal and a point. In one or more examples, the device can be a mobile device, such as a head-mounted device (e.g., an XR device) or a mobile phone.

Particular aspects of the subject matter described in this disclosure can be implemented to realize one or more of the following potential advantages. In one or more examples, the systems and techniques can provide a benefit of improving planarity and completeness of 3D reconstruction, while being lightweight compared to methods requiring neural network inference, which is potentially heavy for on-device execution. In some examples, the systems and techniques can provide a benefit of improving the planarity of surfaces (e.g., a floor or a ceiling) based on accuracy key performance indicators (KPIs) and qualitative assessment. In one or more examples, the systems and techniques can also provide a benefit of reducing the size (e.g., perimeter or surface) of missing surfaces as well as reducing the number of holes in the depth data from a 3D scan of an environment. In some examples, the systems and techniques can provide a benefit of reducing the environment scanning time for a user. In one or more examples, the systems and techniques can provide a benefit of being efficient in terms of inference time and memory consumption. In some examples, the systems and techniques can provide a benefit of operating incrementally, and not requiring a notion of a scan stoppage. In one or more examples, the systems and techniques can provide a benefit of fitting well with the formulations of 3D reconstruction pipelines based on volumetric fusion (e.g., the depth information can be in the form of raw depth data or can be generated from 2D depth completion refinement, and the 3D surface completion can operate on the outputs of the 3D reconstruction pipeline).

Additional aspects of the present disclosure are described in more detail below.

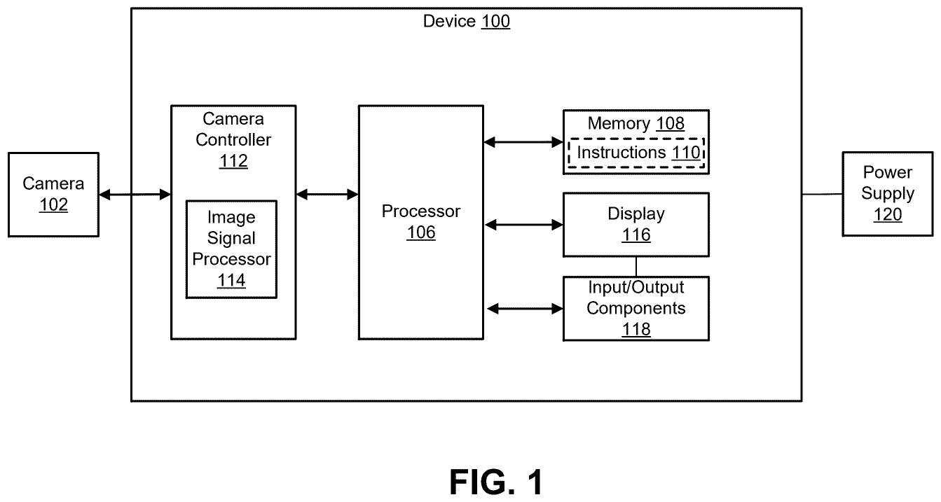

FIG. 1 is a block diagram of an example device 100 that may employ a color metadata buffer for 3D reconstruction. Device 100 may include or may be coupled to a camera 102, and may further include a processor 106, a memory 108 storing instructions 110, a camera controller 112, a display 116, and a number of input/output (I/O) components 118 including one or more microphones (not shown). The example device 100 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 100 may include additional features or components not shown. For example, a wireless interface, which may include a number of transceivers and a baseband processor, may be included for a wireless communication device. Device 100 may include or may be coupled to additional cameras other than the camera 102. The disclosure should not be limited to any specific examples or illustrations, including the example device 100.

Camera 102 may be capable of capturing individual image frames (such as still images) and/or capturing video (such as a succession of captured image frames). Camera 102 may include one or more image sensors (not shown for simplicity) and shutters for capturing an image frame and providing the captured image frame to camera controller 112. Although a single camera 102 is shown, any number of cameras or camera components may be included and/or coupled to device 100. For example, the number of cameras may be increased to achieve greater depth determining capabilities or better resolution for a given FOV.

Memory 108 may be a non-transient or non-transitory computer readable medium storing computer-executable instructions 110 to perform all or a portion of one or more operations described in this disclosure. Device 100 may also include a power supply 120, which may be coupled to or integrated into the device 100.

Processor 106 may be one or more suitable processors capable of executing scripts or instructions of one or more software programs (such as the instructions 110) stored within memory 108. In some aspects, processor 106 may be one or more general purpose processors that execute instructions 110 to cause device 100 to perform any number of functions or operations. In additional or alternative aspects, processor 106 may include integrated circuits or other hardware to perform functions or operations without the use of software. While shown to be coupled to each other via processor 106 in the example of FIG. 1, processor 106, memory 108, camera controller 112, display 116, and I/O components 118 may be coupled to one another in various arrangements. For example, processor 106, memory 108, camera controller 112, display 116, and/or I/O components 118 may be coupled to each other via one or more local buses (not shown for simplicity).

Display 116 may be any suitable display or screen allowing for user interaction and/or to present items (such as captured images and/or videos) for viewing by the user. In some aspects, display 116 may be a touch-sensitive display. Display 116 may be part of or external to device 100. Display 116 may comprise an LCD, LED, OLED, or similar display. I/O components 118 may be or may include any suitable mechanism or interface to receive input (such as commands) from the user and/or to provide output to the user. For example, I/O components 118 may include (but are not limited to) a graphical user interface, keyboard, mouse, microphone and speakers, and so on.

Camera controller 112 may include an image signal processor (ISP) 114, which may be (or may include) one or more image signal processors to process captured image frames or videos provided by camera 102. For example, ISP 114 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 112 (such as the ISP 114) may implement various functionality, including imaging processing and/or control operation of camera 102. In some aspects, ISP 114 may execute instructions from a memory (such as instructions 110 stored in memory 108 or instructions stored in a separate memory coupled to ISP 114) to control image processing and/or operation of camera 102. In other aspects, ISP 114 may include specific hardware to control image processing and/or operation of camera 102. ISP 114 may alternatively or additionally include a combination of specific hardware and the ability to execute software instructions.

While not shown in FIG. 1, in some implementations, ISP 114 and/or camera controller 112 may include an AF module, an AWB module, and/or an AE module. ISP 114 and/or camera controller 112 may be configured to execute an AF process, an AWB process, and/or an AE process. In some examples, ISP 114 and/or camera controller 112 may include hardware-specific circuits (e.g., an application-specific integrated circuit (ASIC)) configured to perform the AF, AWB, and/or AE processes. In other examples, ISP 114 and/or camera controller 112 may be configured to execute software and/or firmware to perform the AF, AWB, and/or AE processes. When configured in software, code for the AF, AWB, and/or AE processes may be stored in memory (such as instructions 110 stored in memory 108 or instructions stored in a separate memory coupled to ISP 114 and/or camera controller 112). In other examples, ISP 114 and/or camera controller 112 may perform the AF, AWB, and/or AE processes using a combination of hardware, firmware, and/or software. When configured as software, AF, AWB, and/or AE processes may include instructions that configure ISP 114 and/or camera controller 112 to perform various image processing and device managements tasks, including the techniques of this disclosure.

As previously mentioned, recently, there has been a demand for 3D content for computer graphics, virtual reality, and communications, that has triggered a change in emphasis for the requirements. Many existing systems for constructing 3D models are built around specialized hardware that results in a high cost, which often cannot satisfy the requirements of these new applications. This need has stimulated the use of digital imaging facilities (e.g., cameras) for 3D reconstruction.

Currently, volume blocks (e.g., voxel blocks) are often used to reconstruct a 3D scene from 2D images (e.g., stereo images obtained from a stereo camera). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

3DR utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four centimeter block dimension. In some examples, for this room, the occupied voxel blocks may only be about ten to fifteen percent.

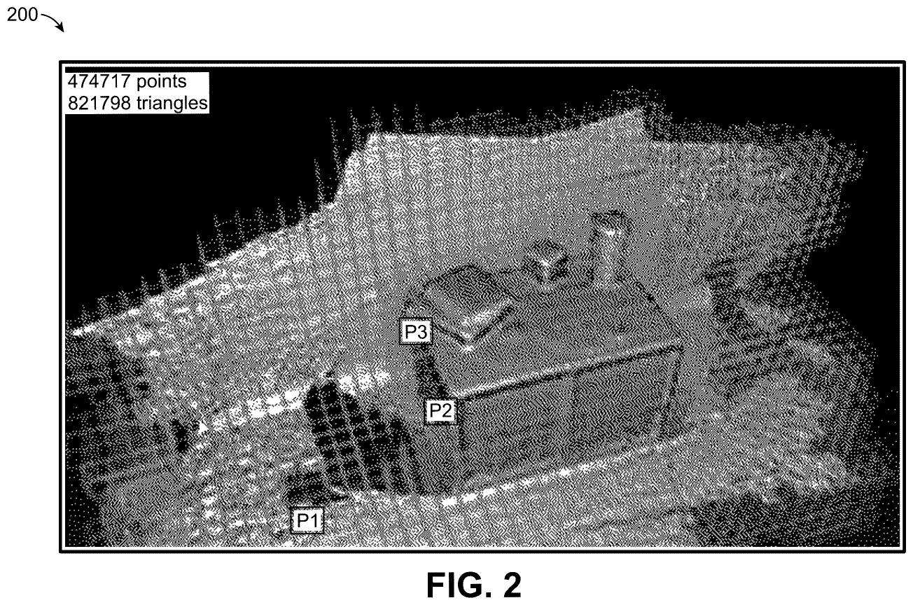

FIG. 2 shows an example of a scene that has been modeled as a 3D sparse volumetric representation for 3DR. In particular, FIG. 2 is a diagram illustrating an example of a 3D surface reconstruction 200 of a scene modeled with an overlay of a volume grid containing voxel blocks. For 3DR, a camera (e.g., a stereo camera) may take photos of the scene from various different view points and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and in some cases can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octrec, and a large blocks implementation.

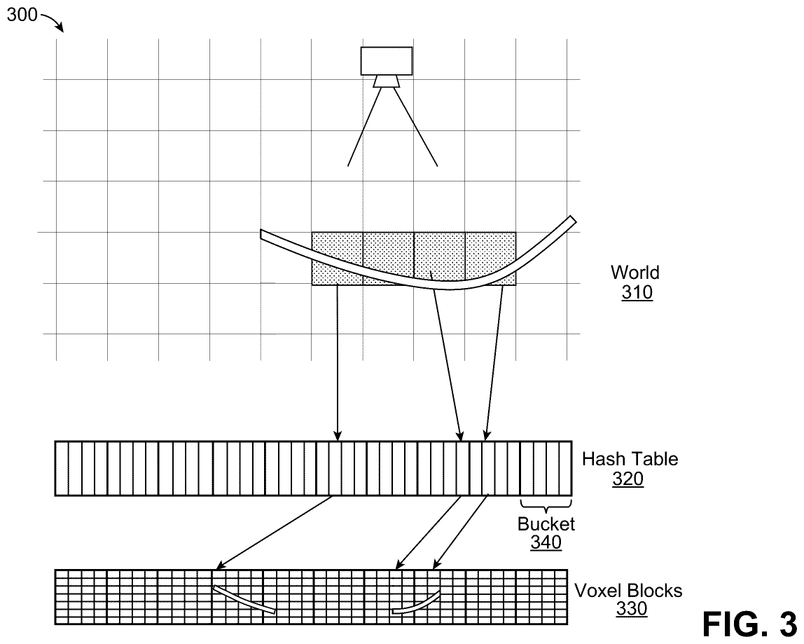

FIG. 3 shows an example of a hash map lookup type of volume block representation. In particular, FIG. 3 is a diagram illustrating an example of a hash mapping function 300 for indexing voxel blocks 330 in a volume grid. In FIG. 3, a volume grid is shown with world coordinates 310. Also shown in FIG. 3 are a hash table 320 and voxel blocks 330. In one or more examples, a hash function can be used to map the integer world coordinates 310 into hash buckets 340 within the hash table 320. The hash buckets 340 can each store a small array of points to regular grid voxel blocks 330. Each voxel block 330 contains data that can be used for depth integration.

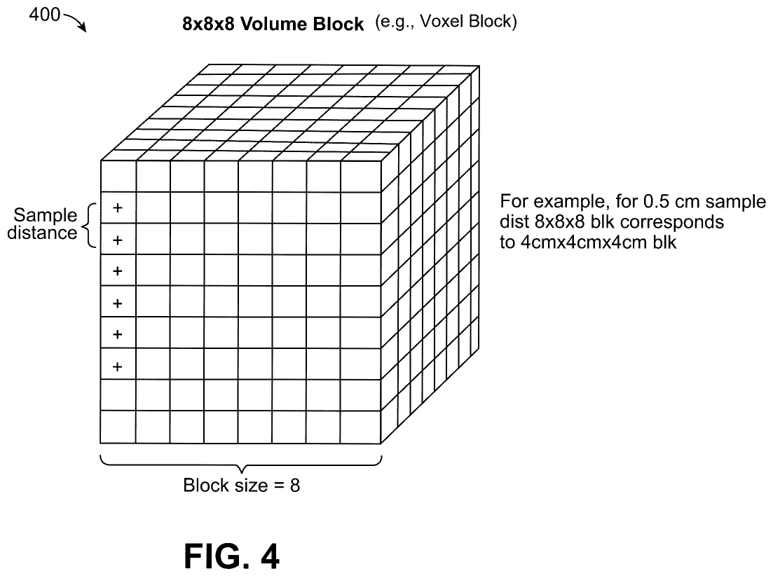

FIG. 4 is a diagram illustrating an example of a volume block (e.g., a voxel block) 400. In FIG. 4, the voxel block 400 is shown to have a block size of eight. For example, a 0.5 centimeter (cm) sample distance for an eight by eight by eight voxel block can correspond to a four cm by four cm by four cm voxel block. That is, the voxel block 400 includes a 3D lattice of 512 voxels, the voxels arranged so that the voxel block 400 has a width of 8 voxels, a length of 8 voxels, and a height of 8 voxels.

In one or more examples, each voxel block (e.g., voxel block 400) can contain or store truncated signed distance function (TSDF) samples and a weight. In some cases, each voxel can also contain or store color values (e.g., red-green-blue (RGB) values). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [-1, 1], for example based on Equation (1) below:

$$\begin{matrix}tsdf = \{ \begin{matrix}- 1 , & if d \leq - ramp \\ \frac{d}{ramp} , & if - ramp < d < ramp \\ 1 , & if d \geq ramp\end{matrix} \} \\ sample . tsdf = ( \frac{sample . weight * sample . tsdf + tsdf}{sample . weight + 1} )\end{matrix} \qquad Equation ( 1 )$$

A TSDF integration or fusion process can be employed that updates the TSDF values and weights with each new observation from the sensor (e.g., camera).

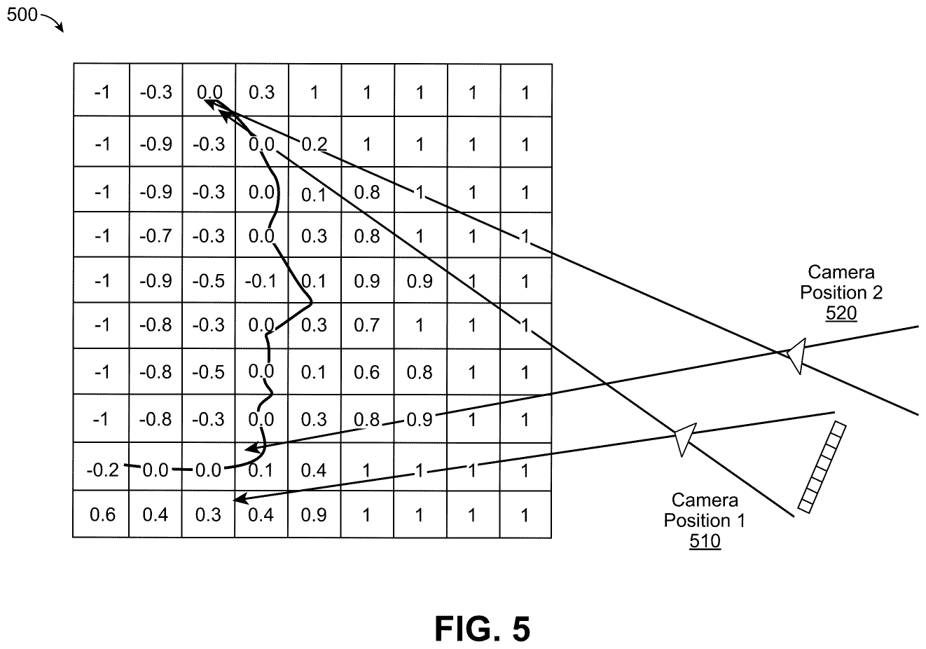

FIG. 5 is a diagram illustrating an example of a TSDF volume reconstruction 500. In FIG. 5, a voxel grid including a plurality of voxel blocks is shown. A camera is shown to be obtaining images of a scene (e.g., person's face) from two different camera positions (e.g., camera position 1 510 and camera position 2 520). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 5, the voxel blocks with positive values are shown to be located in front of the person's face, the voxel blocks with negative values are shown to be located inside of the person's face, and the voxel blocks with zero values are shown to be located on the surface of the person's face.

As previously mentioned, in 3DR, 3D scenes are represented using a 3D volume of points called voxel blocks. Typically, each voxel block carries implicit surface information (e.g., in the form of a TSDF value and a weight for depth integration). The TSDF value is a measure of distance of the voxel block from a surface. The weight is a measure of the reliability of the TSDF value. In some cases, a TSDF weight may be estimated using various approaches, such as a simple counter (e.g., a binary weight, such as 1 or 0), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to 1.

A 3DR system can utilize a sequence of depth maps of a scene with their corresponding 6 degrees of freedom (DoF) poses as an input. The depth maps may be generated using deep learning (DL), non-DL, and/or other depth estimation algorithms or methods. A 3D space of the scene may be uniformly sampled along the X, Y, and Z directions. The 3D space may be divided into fixed size volumes (e.g., block volumes with a fixed number of samples).

A 3DR system generally consists of three stages, which include block selection, integration, and surface extraction. During block selection, all of the blocks that have surfaces or are located close to a surface may be selected. These blocks may then be allocated into memory. In block integration, all voxel blocks within a block volume may be iterated over and an updated TSDF value weight can be calculated. In surface extraction, marching cubes may be used to determine triangular surfaces in the blocks.

In block selection, depth pixels may be iterated over to unproject them to a 3D space and determine where they lie within the 3D space using intrinsic and extrinsic camera parameters. Usually, a hash map is employed for block selection. A hash map is an unordered map, which includes a listing of blocks (e.g., including block indices of the blocks) that have a surface. The hash map may include a corresponding counter for each of the blocks that maintains a count of the number of times depth pixels lie within the particular block. A threshold (e.g., threshold value or number) may be used to select all the blocks that have depth pixels that lie within them for more than the threshold number of times. The selected blocks may then be integrated.

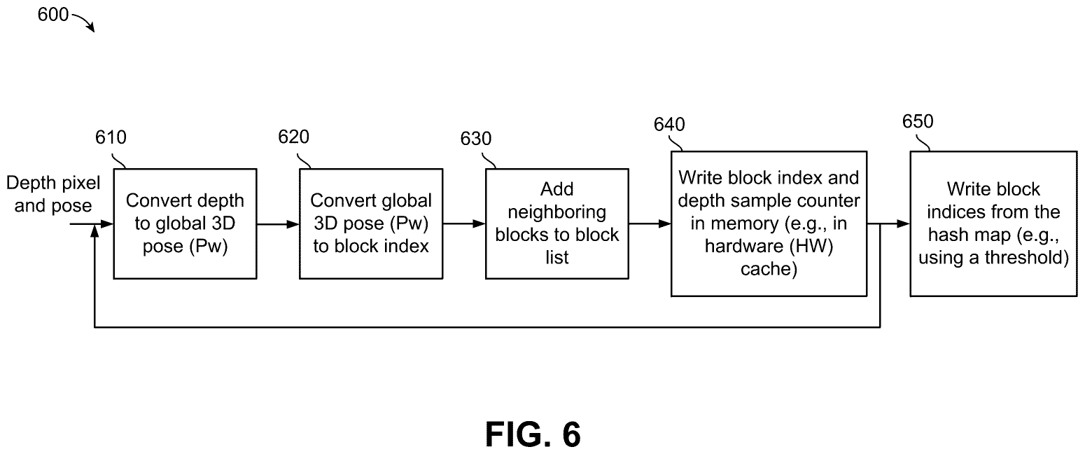

FIG. 6 shows an example voxel block selection algorithm for 3DR of a scene. In particular, FIG. 6 is a diagram illustrating an example of a voxel block selection algorithm 600. In FIG. 6, for operation of the voxel block selection algorithm 600, a plurality of depth pixels associated with a plurality of depth maps of the scene can be obtained by one or more processors (e.g., image signal processor 114 of FIG. 1). In one or more examples, each depth map of the plurality of depth maps is associated with a respective pose (e.g., a 6 DoF pose) of an image sensor (e.g., a camera, such as camera 102 of FIG. 1). In some examples, each depth pixel of the plurality of depth pixels is associated with a depth value. The one or more processors can iterate the algorithm 600 over every depth value in the depth maps.

During operation of the voxel block selection algorithm 600, at operation 610, the one or more processors can convert the depth values of the plurality of depth pixels to a plurality of global three-dimensional (3D) points in a global coordinate system. In one or more examples, the converting of the depth values of the plurality of depth pixels to the plurality of global 3D points in the global coordinate system can be achieved by the one or more processors unprojecting the depth values to a 3D space.

At operation 610, the one or more processors can determine indices of blocks (e.g., voxel blocks) associated with the plurality of global 3D points. At operation 630, the one or more processors can generate a listing of blocks including the indices of the blocks associated with the plurality of global 3D points and indices of neighboring blocks adjacent (e.g., next to or close) to the blocks associated with the plurality of global 3D points.

The one or more processors can then select the plurality of blocks of the scene from the listing of blocks based on a number of depth pixels of the plurality of depth pixels being located within the plurality of blocks. For example, at operation 640, the one or more processors can increment a counter for each block in the listing of blocks each time a depth pixel of the plurality of depth pixels is located within each block. The one or more processors can write the indices and the corresponding counter values of the blocks in the listing of the blocks in memory (e.g., a hardware cache).

At operation 650, the one or more processors can determine blocks in the listing of blocks with a counter value greater than a threshold value (e.g., a threshold number). The one or more processors can then select the plurality of blocks of the scene based on the blocks in the listing of blocks with the counter value greater than the threshold value. The one or more processors can write the indices of the selected plurality of blocks of the scene in memory (e.g., the hardware cache).

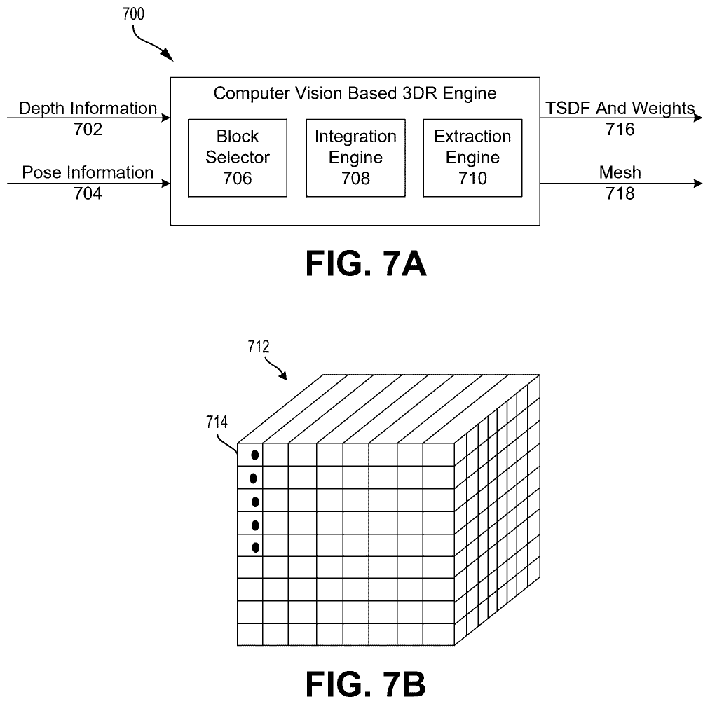

Performing 3D scene reconstruction (e.g., to generate a 3D representation of an environment) from images can be challenging. Traditionally, 3DR may be performed using computer vision (CV) techniques. As used here, CV techniques may refer techniques that do not use machine learning or deep learning, such as depth integration, TSDF fusion, which may compute a 3D representation from a 2D depth map. Such techniques typically use a depth map (e.g., depth image) along with an input image and pose information to generate a 3D mesh of the scene. FIG. 7A is a block diagram illustrating a CV 3DR engine 700. In some cases, the CV 3DR engine 700 may be implemented, in part or as a whole, in hardware, for example, as one or more circuits, which may be a part of a system on a chip (SoC), processor, etc. In other cases, the CV 3DR engine 700 may be software implemented. The CV 3DR engine 700 may take, as input depth information 702 and pose information 704 for a scene and the CV 3DR engine 700 may include a block selector 706, integration engine 708, and an extraction engine 710. In some cases, the depth information 702 may be monocular depth information (e.g., captured using a single camera) and may be derived, for example, using depth from stereo, ML based depth sensing, etc. The depth information 702 may be a depth map corresponding to a received image. The pose information 704 may be information about a device's location and/or orientation within the environment.

In some cases, the block selector 706 may select 3D spaces visible by the camera that are likely to include objects/surfaces, based on the depth information 702. For example, the block selector 706 may project an image into 3D space, for example, using the depth information and selecting volume blocks in which a pixel may be in based on the depth information. As shown in FIG. 7B, a volume block 712 may be a block of voxels (e.g., voxel 714, which may be 3D pixels for an area of an environment captured by an image), such as an 8×8×8 block of voxels. The block selector 706 may output a list of block indices indicating which blocks likely have object/surfaces in them. The integration engine 708 may, based on the list of block indices, convert the depth information into an implicit surface representation, such as a truncated sign distance function (TSDF).

As previously mentioned, the TSDF may be a function which measures a distance d for each 3D point or voxel to the closest point on a surface of an object. Positive TSDF values may indicate that a voxel of a volume block is in front of a surface, negative TSDF values may indicate that a voxel of the volume block is within (e.g., behind, inside, etc.) the surface, and a 0 TSDF value may indicate the surface. In some cases, the distance d may be truncated to −1, 1 using a threshold. This threshold may be called a ramp. The TSDF may be determined based on the equation 1 above.

In some cases, the block selector 706 may update the TSDF values and weights as images are received from the device. In some cases, the weight may be a counter corresponding to a voxel to track how many times the voxel has been visited. For example, based on the depth and camera position, the block selector may determine which voxels should be visited. During the visit, the voxel's previous TSDF value may be updated based on the depth and camera pose information and the voxel's weight may be added with one. The extraction engine 710 may take a volume block 712 and generates a mesh, for example, using a marching cubes algorithm, to generate the mesh from the TSDF grid. In some cases, the CV 3DR engine 700 may output the TSDF values and weights 716 per volume block 712 along with the generated mesh 718.

In some cases, CV techniques can produce high quality, high resolution, 3D representations of a scene. For example, a hardware implemented CV technique may be able to provide multiple (e.g., 32, 64, etc.) TSDF values per volume block 712. However, CV techniques may be sensitive to a quality of the depth map. For example, environments may include featureless objects (or other objects with relatively fewer features), such as solid-colored walls, and it may be difficult to obtain depth information across such featureless objects using optical-based depth measurement techniques, such as depth from stereo or monocular depth techniques. In some cases, such featureless objects may result in holes in the depth map. As another example, depth information obtained using indirect techniques such as depth from stereo can be noisy and vary from frame to frame. This noise may result in noisy and/or distortions in the depth map.

As previously mentioned, recently, there has been a demand for 3D content for computer graphics, virtual reality, and communications. To reconstruct a 3D scene of an environment, multiple image frames of the environment need to be captured by an image-capturing device (e.g., including an image sensor), such as an XR head-mounted device (e.g., glasses) or a mobile phone. A thorough scanning of the environment can be a challenging process that can lead to unwanted artifacts in the 3D reconstruction. These artifacts in the 3D reconstruction can include constructing non-planar surfaces, which are naturally planar in reality (e.g., a floor), due to noise in the reconstruction data (e.g., including depth, sensor data, sensor pose, and/or sensor calibration parameters).

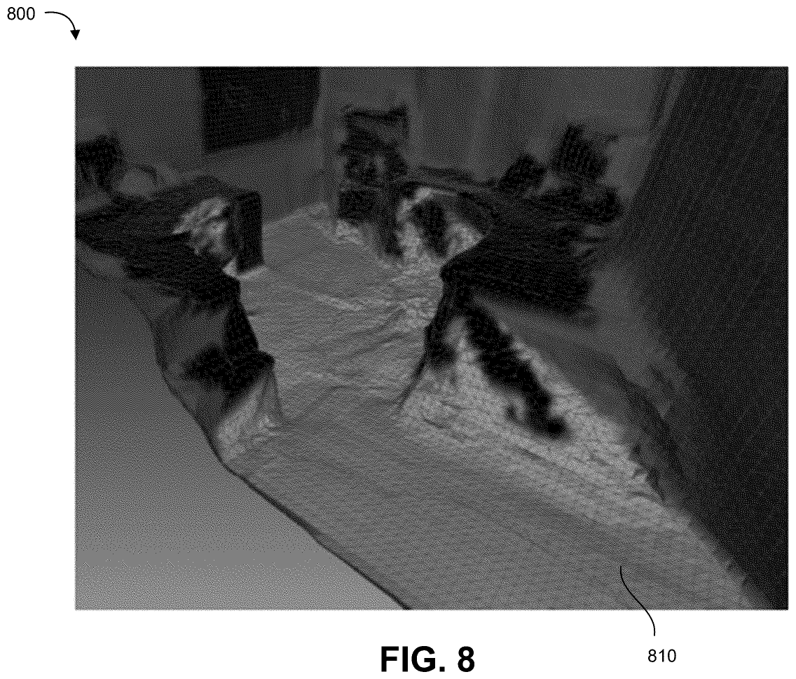

FIG. 8 shows an example of a 3D reconstruction of a scene of a room where, due to noise in the reconstruction data (e.g., the depth data), the planar floor has been constructed as a non-planar surface. In particular, FIG. 8 is a diagram illustrating an example of a 3D reconstruction 800 of a scene using a depth map generated by machine learning (e.g., based on one or more images captured by one or more image sensors). Depth maps generated from machine learning are typically dense (e.g., have dense depth data), but often have inconsistent depth values between the image frames. As such, FIG. 8 shows that the 3D reconstruction 800 of the scene constructed (e.g., based on the depth map, generated by machine learning, with inconsistent depths) the floor 810, which is naturally a planar surface, to be bumpy and non-planar.

The artifacts in the 3D reconstruction can also include constructing holes in planar structures, which do not have holes in reality, due to missing geometry (e.g., incomplete depth data). For example, time of flight (TOF) sensors, used to obtain depth data, often do not perform well on reflective or dark surfaces and, as such, can produce sparse depth data.

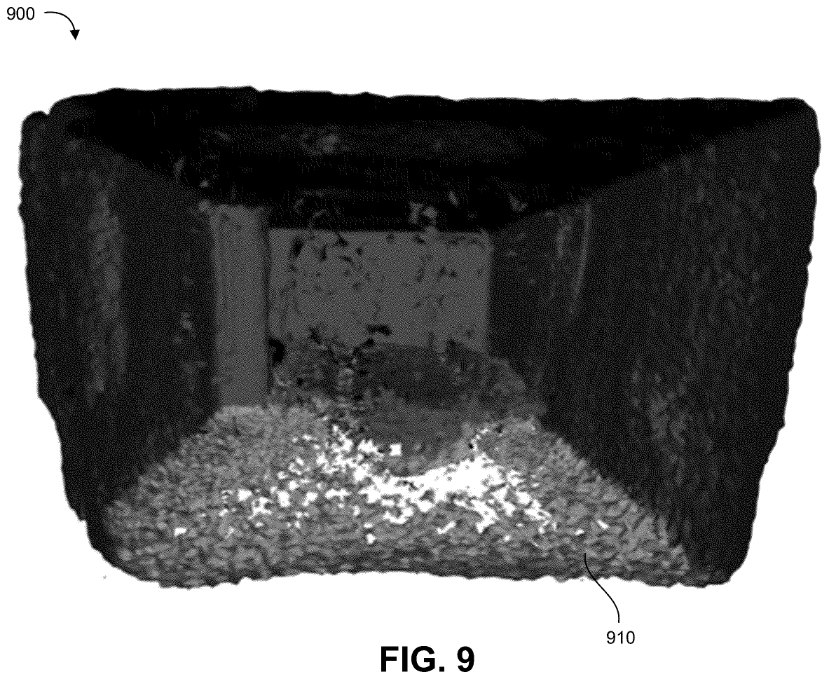

FIG. 9 shows an example of a 3D reconstruction of a scene of a room where, due to incomplete reconstruction data (e.g., incomplete depth data), the planar floor has been constructed as a non-planar surface with many holes. In particular, FIG. 9 is a diagram illustrating an example of a 3D reconstruction 900 of a scene using a depth map generated by a TOF sensor. Depth maps generated from TOF sensors are generally sparse (e.g., have sparse depth data), and can have inaccurate depth values due to TOF sensors not performing well on reflective or dark surfaces. As such, FIG. 9 shows that the 3D reconstruction 900 of the scene constructed (e.g., based on the depth map, generated by a TOF sensor, with sparse and inaccurate depth data) the floor 910, which is naturally a uniform, planar surface, to be very bumpy and with many holes.

As such, accurate and complete planar geometry is extremely important to generate an accurate 3D reconstruction, which can facilitate an immersive experience for a user of XR. Accurate and complete planar geometry can facilitate realistic virtual object placement, and can prevent the possibility of a virtual object falling through a hole in a scene resulting from sparse depth data. Therefore, improved systems and techniques for providing accurate and complete planar geometry can be useful.

In one or more aspects, the systems and techniques can provide solutions for semantically-guided planar 3D reconstruction. Various aspects relate generally to image processing. Some aspects more specifically relate to systems and techniques that provide solutions that incorporate efficient semantically-driven planar constraints to improve the quality of a 3D reconstruction. The systems and techniques leverage existing semantic information to refine input depth data before performing the 3D reconstruction. In one or more examples, the systems and techniques can smooth out a planar surface by utilizing a TSDF volume, not a mesh. In some examples, the systems and techniques employ an algorithm that first integrates N number of frames without planar constraints to obtain a semantic TSDF volume. Once a surface plane (e.g., a planar prior, which is a prior depth map for a planar surface) is estimated, the virtual plane may be projected to a camera view of a depth sensor to modify depth readings from the depth sensor. The refined depth may then be integrated into the 3D reconstructed model.

In one or more examples, the systems and techniques can be applied to different use cases. For example, in the real world, surfaces (e.g., in a room) are typically quite planar. A floor, ceiling, or wall is usually a flat surface (e.g., mostly planar). In virtual reality, if a floor, for example, is not constructed to be mostly planar, the overall user experience can be adversely affected. If a surface (e.g., a floor) is planar, it is easier to estimate a plane for the surface rather than using a mesh representation (e.g., which uses vertices and triangles) for the surface. Improving the planarity of a room geometry can lead to more robust object placement (e.g., a virtual carpet on the floor) for virtual reality use cases.

A complete 3D scene reconstruction can be essential for many XR applications. For example, occlusion rendering applications use depth and object segmentation to render virtual objects in a 3D environment. If there are holes in the depth data, a virtual object might unrealistically fall through a surface, which can ruin the immersive experience of XR for a user. For another example, collision avoidance applications can also use depth to estimate distance to objects. Incomplete depth data can lead to inaccurate distance estimations to objects, which can impair the collision avoidance.

In one or more aspects, the systems and techniques can be used to improve planarity can completeness of 3D surfaces. In one or more examples, the systems and techniques incorporate planar constraints to improve the quality of the 3D reconstruction. A planar constraint can be incorporated to refine input depth data before the 3D reconstruction (e.g., before an integration stage). In some examples, the systems and techniques leverage existing semantic information (e.g., a floor or ceiling segmentation mask). The systems and techniques are lightweight and consistent in 3D, and provide a pure multi-view geometry solution that does not require neural network training or adaptation for different sensors and devices.

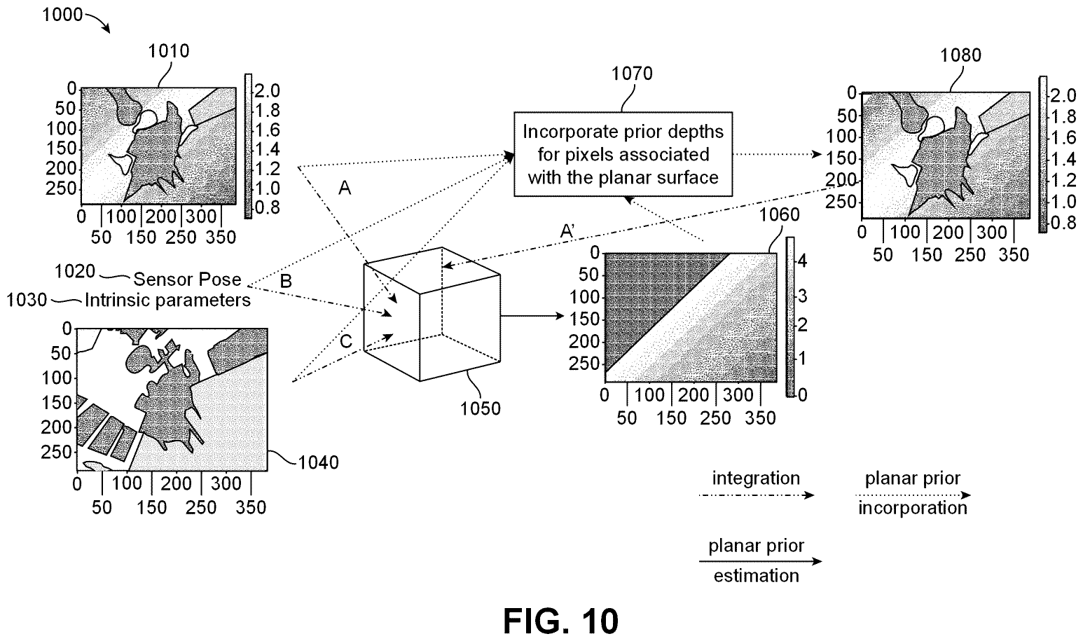

FIG. 10 is a diagram illustrating an example of a process 1000 to improve the planarity and completeness of a 3D planar surface. In FIG. 10, a depth map 1010 (e.g., a first depth map) corresponding to a scene (e.g., a room including a dining table on a floor of the room) and a semantic segmentation map 1040 (e.g., a first semantic segmentation map) of the scene are shown.

In one or more examples, during operation of the process 1000 to improve the planarity and completeness of a 3D planar surface (e.g., a floor, a ceiling, or a wall), a sensor of a device may generate the depth map 1010 corresponding to the scene. In some examples, the sensor may be a TOF sensor or an image sensor (e.g., which can use one or more machine learning algorithms to generate the depth map 1010). In one or more examples, the device may be a mobile device, such as a head-mounted device (e.g., an XR device) or a mobile phone.

In some examples, one or more processors of the device may generate the semantic segmentation map 1040 based on (e.g., by using) semantic segmentation. Semantic segmentation is a computer vision task that assigns a class label to pixels within an image by using a machine learning algorithm. Semantic segmentation tasks help machines to distinguish between different object classes (e.g., a table) and background regions (e.g., a floor, a wall, and a ceiling) within an image. As such, the semantic segmentation map 1040 can include labels for different objects (e.g., a table) and regions (e.g., a floor, a wall, and a ceiling) within the scene.

In one or more examples, one or more processors of the device can generate, based on (e.g., as indicated by arrows A and C in FIG. 10) the depth map 1010 (e.g., the first depth map) corresponding to the scene and the semantic segmentation map 1040 (e.g., the first semantic segmentation map) of the scene, a plurality of first blocks (e.g., including block 1050) that may be associated with a planar surface (e.g., a floor) within the scene. In one or more examples, the planar surface can be a floor, a wall, or a ceiling.

In some examples, generating the plurality of first blocks (e.g., including the block 1050) that may be associated with the planar surface (e.g., the floor) within the scene can be further based on (e.g., as indicated by arrow B in FIG. 10) a sensor pose 1020 (e.g., a pose of the sensor, for example the TOF sensor) and intrinsic parameters 1030 of the sensor (e.g., the TOF sensor). As such, the one or more processors can integrate together (e.g., as indicated by arrows A, B, and C in FIG. 10) the depth map 1010 (e.g., the first depth map), the semantic segmentation map 1040 (e.g., the first semantic segmentation map), the sensor pose 1020, and the intrinsic parameters 1030 of the sensor to generate the plurality of first blocks (e.g., including the block 1050) that may be associated with the planar surface (e.g., the floor) within the scene. In one or more examples, each block (e.g., block 1050) of the plurality of first blocks can be a voxel. In some examples, the voxel may be a semantic truncated signed distance function (TSDF) volume.

The one or more processors can determine (e.g., extract), based on the plurality of first blocks (e.g., including the block 1050) that may be associated with the planar surface (e.g., the floor), a representation of the planar surface (e.g., the floor). In one or more examples, the representation of the planar surface (e.g., the floor) may be an equation for the planar surface (e.g., an estimation of the planar surface). In some examples, the representation of the planar surface may be a surface plane equation representing the planar surface as a normal (e.g., normal to the surface) and a point.

The one or more processors can replace, based on the representation of the planar surface (e.g., the planar surface equation), first depths for pixels associated with the planar surface (e.g., the floor) in the depth map 1010 (e.g., the first depth map) with second depths for the pixels associated with the planar surface (e.g., the floor) from a prior depth map 1060 corresponding to the scene to generate an updated depth map 1080 corresponding to the scene. As such, the one or more processors can (e.g., at block 1070) incorporate prior depths (e.g., from the prior depth map 1060) for pixels associated with the planar surface (e.g., the floor) into the depth map 1010 (e.g., the first depth map) to generate the updated depth map 1080. In one or more examples, the prior depth map 1060 may be previously generated by the one or more processors.

The one or more processors can generate, based on (e.g., as indicated by arrows A′ and C in FIG. 10) the updated depth map 1080 corresponding to the scene and the semantic segmentation map 1040 (e.g., the first semantic segmentation map) of the scene, a plurality of second blocks (e.g., updated blocks) associated with the planar surface (e.g., the floor) within the scene. In some examples, generating the plurality of second blocks (e.g., updated blocks) associated with the planar surface (e.g., the floor) within the scene can be further based on (e.g., as indicated by arrow B in FIG. 10) the sensor pose 1020 (e.g., the pose of the sensor, for example the TOF sensor) and the intrinsic parameters 1030 of the sensor (e.g., the TOF sensor). As such, the one or more processors can integrate together (e.g., as indicated by arrows A′, B, and C in FIG. 10) the updated depth map 1080, the semantic segmentation map 1040 (e.g., the first semantic segmentation map), the sensor pose 1020, and the intrinsic parameters 1030 of the sensor to generate the plurality of second blocks (e.g., updated blocks) associated with the planar surface (e.g., the floor) within the scene. In one or more examples, each block of the plurality of second blocks can be a voxel. In some examples, the voxel can be a semantic TSDF volume. Thus, the plurality of second blocks (e.g., updated blocks) can include more accurate depths for the planar surface (e.g., the floor) than the first plurality of blocks. These more accurate depths can be used to construct an accurate 3D reconstruction of the scene.

In one or more aspects, a conventional 3D reconstruction pipeline requires a depth map, sensor (e.g., a TOF sensor) calibration parameters (e.g., intrinsic parameters), and a sensor pose. In one or more examples, an algorithm for an improved 3D reconstruction pipeline to improve the planarity and completeness of a 3D planar surface can involve first integrating N number (e.g., where N is a tunable parameter) of frames (e.g., initial depth maps) without planar constraints to obtain a plurality of initial blocks (e.g., semantic TSDF volumes). After the N number of frames (e.g., depth maps) are integrated and enough observations of the planar surface (e.g., a floor) is available, a surface equation for the planar surface (e.g., which may be represented as a normal and a point) can be estimated. Every time there is a new depth map, the virtual plan can be projected to the camera view of the depth sensor (e.g., TOF sensor) and the depth readings of the sensor can be modified (e.g., by conditioning on semantic information) with depth values from the planar constraint. The refined (or updated) depth map can then be integrated as usual.

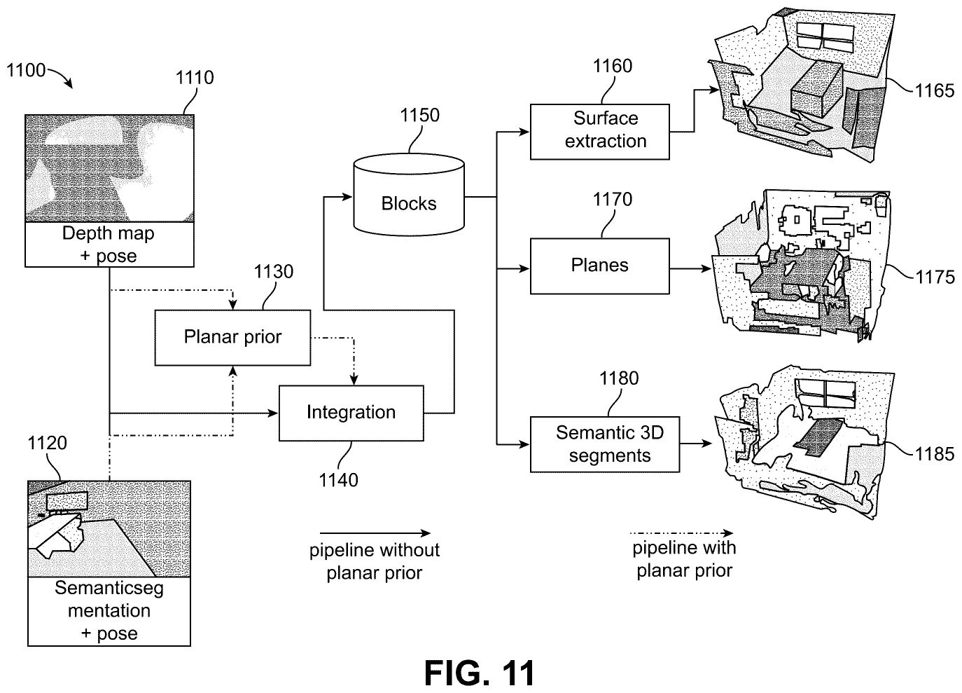

FIG. 11 shows an example of a process (e.g., algorithm) for an improved 3D reconstruction pipeline to improve the planarity and completeness of a 3D planar surface. In particular, FIG. 11 is a diagram illustrating an example of a process 1100 that incorporates planar constraints to improve the quality of a 3D reconstruction of a scene.

In one or more examples, during operation of the process 1100 of FIG. 11, at the planar prior block 1130, one or more processors of a device (e.g., a mobile device, such as an XR drive or a mobile phone) can generate, based on a plurality of depth maps (e.g., N number of initial depth maps, where N is a tunable parameter) corresponding to the scene with a corresponding sensor pose 1110 and a plurality of semantic segmentation maps (e.g., N number of initial semantic segmentation maps) of the scene with a corresponding sensor pose 1120, a plurality of blocks (e.g., initial blocks or third blocks) that may be associated with a planar surface (e.g., a floor) of the scene. In one or more examples, the requirement on using N number of initial depth maps can be a guard against using a poor initial plane estimation.

In some examples, the one or more processors can further determine, based on an area (e.g., a region) of the planar surface (e.g., the floor) covered by the plurality of blocks (e.g., the initial blocks or third blocks) being greater than an area threshold value (e.g., a percentage value, such as ninety percent, of the planar surface that is covered, or a size, such as in square meters, for the covered area of the planar surface), a prior depth map (e.g., the prior depth map 1060 of FIG. 10) based on the plurality of depth maps (e.g., the N number of initial depth maps). In one or more examples, the requirement on the area of the planar surface covered by the plurality of blocks (e.g., which is similar to a requirement on a number of observations of the plurality of blocks belonging to a semantic class (e.g., the floor) of the planar surface) can be a guard against using a poor initial plane estimation.

In one or more examples, at the integration block 1140, the process 1000 of FIG. 10 may be performed. For example, at the integration block 1140, the one or more processors of the device can generate, based on (e.g., integrating) a depth map (e.g., a first depth map) corresponding to the scene with a corresponding sensor pose 1110 and a semantic segmentation map (e.g., a first semantic segmentation map) of the scene with a corresponding sensor pose 1120, a plurality of first blocks (e.g., semantic TSDF volumes) that may be associated with the planar surface (e.g., the floor) within the scene.

The one or more processors can determine (e.g., extract), based on the plurality of first blocks that may be associated with the planar surface (e.g., the floor), a representation of the planar surface (e.g., the floor). The one or more processors can replace, based on the representation of the planar surface (e.g., a planar surface equation), first depths for pixels associated with the planar surface (e.g., the floor) in the first depth map with second depths for the pixels associated with the planar surface (e.g., the floor) from the prior depth map (e.g., generated at the planar prior block 1130) corresponding to the scene to generate an updated depth map corresponding to the scene.

In one or more examples, replacing the first depths for the pixels associated with the planar surface in the first depth map with the second depths for the pixels associated with the planar surface from the prior depth map (e.g., generated at the planar prior block 1130) can be further based on a difference in the first depths and the second depths being less than a depth threshold value (e.g., which may be in centimeters (cm) or meters (m), such as a value of 5 cm, 10 cm, 1 m, etc.). In one or more examples, when the difference in the first depths and the second depths is not less than the depth threshold value, the first depths for the pixels associated with the planar surface in the first depth map will not be replaced with the second depths for the pixels associated with the planar surface from the prior depth map (e.g., generated at the planar prior block 1130).

In one or more examples, replacing the first depths for the pixels associated with the planar surface in the first depth map with the second depths for the pixels associated with the planar surface from the prior depth map (e.g., generated at the planar prior block 1130) can be further based on a confidence of the semantic labels for the pixels associated with the planar surface in the semantic segmentation map (e.g., the first semantic segmentation map) being higher than a confidence threshold value (e.g., which may be a percentage value, such as ninety percent). In one or more examples, when the confidence of the semantic labels for the pixels associated with the planar surface in the semantic segmentation map (e.g., the first semantic segmentation map) is not higher than the confidence threshold value, the first depths for the pixels associated with the planar surface in the first depth map will not be replaced with the second depths for the pixels associated with the planar surface from the prior depth map (e.g., generated at the planar prior block 1130).

The one or more processors can then generate, based on (e.g., integrating) the updated depth map corresponding to the scene and the semantic segmentation map (e.g., the first semantic segmentation map) of the scene with the corresponding sensor pose 1120, a plurality of second blocks (e.g., updated blocks 1150) associated with the planar surface (e.g., the floor) within the scene. As such, the plurality of second blocks (e.g., the updated blocks 1150) can include more accurate depths for the planar surface (e.g., the floor) than the first plurality of blocks. The plurality of second blocks (e.g., the updated blocks 1150) with the more accurate depths can then be used for various different applications, such as a surface extraction application 1160 for generating a mesh map 1165, a plane generation application 1170 for generating a plane map 1175, and/or a semantic 3D segmentation application 1180 for generating a semantic segmentation map 1185.

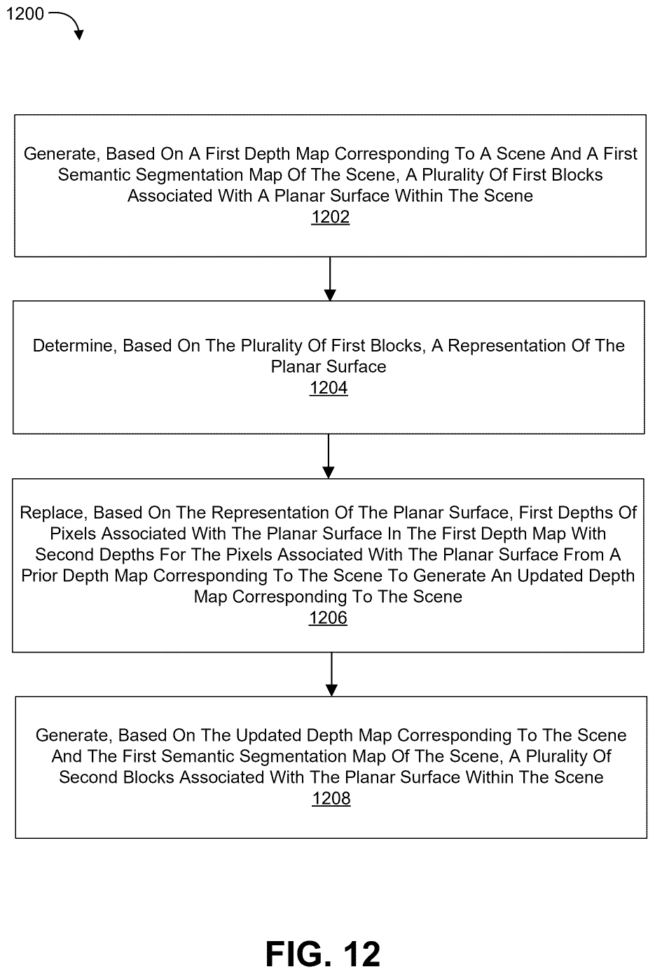

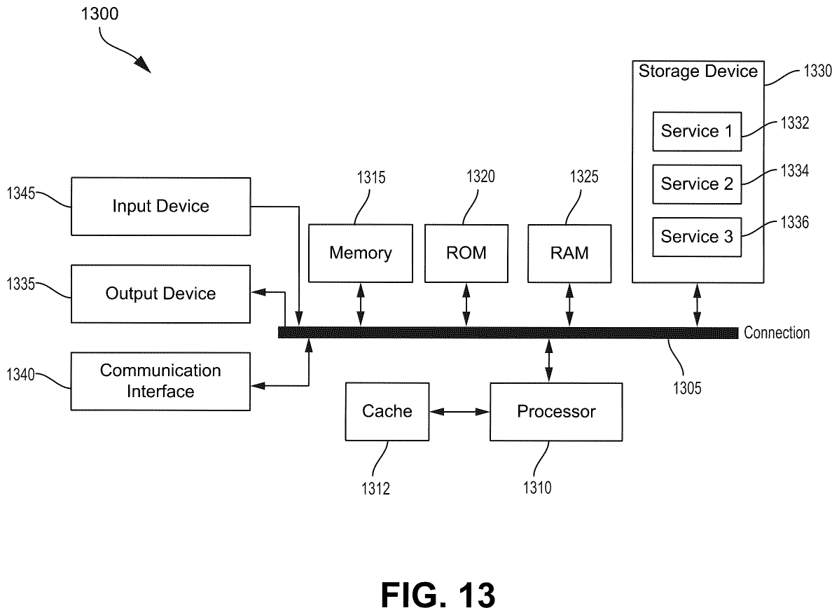

FIG. 12 is a flow chart illustrating an example of a process 1200 for image processing. The process 1200 can be performed by a computing device (e.g., a computing device or computing system 1300 of FIG. 13) or by a component or system (e.g., a chipset, one or more processors such as a neural processing unit (NPU), a neural signal processor (NSP), a digital signal processor (DSP), a graphics processing unit (GPU), a central processing unit (CPU), any combination thereof, and/or other processor(s), or other component or system) of the computing device. The operations of the process 1200 may be implemented as software components that are executed and run on one or more processors (e.g., processor 1310 of FIG. 13, or other processor(s)). Further, the transmission and reception of signals by the computing device in the process 1200 may be enabled, for example, by one or more antennas and/or one or more transceivers (e.g., wireless transceiver(s)).

At block 1202, the computing device (or component thereof) can generate, based on a first depth map corresponding to a scene and a first semantic segmentation map of the scene, a plurality of first blocks associated with a planar surface within the scene (e.g., a floor, a wall, a ceiling, or other planar surface of the scene). In some aspects, each block of the plurality of first blocks is a voxel. In some cases, the voxel is or is part of a semantic truncated signed distance function (TSDF) volume. In some aspects, the computing device (or component thereof) can generate, based on sensor data from a sensor, the first depth map corresponding to the scene. In some examples, the sensor is a time of flight (TOF) sensor, an image sensor, a LIDAR sensor, a RADAR sensor, any combination thereof and/or other type of sensor. The sensor data can include a plurality of points (e.g., including three-dimensional (3D) points, with each 3D point have 3D coordinates in space), such as a point cloud. The depth map can be a two dimensional (2D) representation of the plurality of points (e.g., based on projecting the 3D points to a 2D image plane). In some cases, the computing device (or component thereof) can generate the plurality of first blocks associated with the planar surface within the scene further based on a pose of the sensor and intrinsic parameters of the sensor.

At block 1204, the computing device (or component thereof) can determine, based on the plurality of first blocks, a representation of the planar surface. In some aspects, the representation of the planar surface is a surface plane equation representing the planar surface as a normal and a point.

At block 1206, the computing device (or component thereof) can replace, based on the representation of the planar surface, first depths for pixels associated with the planar surface in the first depth map with second depths for the pixels associated with the planar surface from a prior depth map corresponding to the scene to generate an updated depth map corresponding to the scene. In some aspects, the computing device (or component thereof) can replace the first depths for the pixels associated with the planar surface in the first depth map with the second depths for the pixels associated with the planar surface from the prior depth map further based on a difference in the first depths and the second depths being less than a depth threshold value. In some cases, the computing device (or component thereof) can generate, based on a plurality of depth maps corresponding to the scene and a plurality of second semantic segmentation maps of the scene, a plurality of third blocks associated with the planar surface within the scene. In some examples, the computing device (or component thereof) can determine, based on an area of the planar surface covered by the plurality of third blocks being greater than an area threshold value, the prior depth map based on the plurality of depth maps.

At block 1208, the computing device (or component thereof) can generate, based on the updated depth map corresponding to the scene and the first semantic segmentation map of the scene, a plurality of second blocks associated with the planar surface within the scene. In some aspects, the computing device (or component thereof) can generate the plurality of second blocks associated with the planar surface within the scene further based on the pose of the sensor and the intrinsic parameters of the sensor noted previously.

In some cases, the computing device of process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1200 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed for semantically-guided planar 3D reconstruction. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LIDAR sensors, RADAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: generate, based on a first depth map corresponding to a scene and a first semantic segmentation map of the scene, a plurality of first blocks associated with a planar surface within the scene; determine, based on the plurality of first blocks, a representation of the planar surface; replace, based on the representation of the planar surface, first depths for pixels associated with the planar surface in the first depth map with second depths for the pixels associated with the planar surface from a prior depth map corresponding to the scene to generate an updated depth map corresponding to the scene; and generate, based on the updated depth map corresponding to the scene and the first semantic segmentation map of the scene, a plurality of second blocks associated with the planar surface within the scene.

Aspect 2. The apparatus of Aspect 1, wherein the at least one processor is configured to generate, based on a plurality of depth maps corresponding to the scene and a plurality of second semantic segmentation maps of the scene, a plurality of third blocks associated with the planar surface within the scene.

Aspect 3. The apparatus of Aspect 2, wherein the at least one processor is configured to determine, based on an area of the planar surface covered by the plurality of third blocks being greater than an area threshold value, the prior depth map based on the plurality of depth maps.

Aspect 4. The apparatus of any of Aspects 1 to 3, wherein the at least one processor is configured to replace the first depths for the pixels associated with the planar surface in the first depth map with the second depths for the pixels associated with the planar surface from the prior depth map further based on a difference in the first depths and the second depths being less than a depth threshold value.

Aspect 5. The apparatus of any of Aspects 1 to 4, wherein the at least one processor is configured to generate, based on sensor data from a sensor, the first depth map corresponding to the scene.

Aspect 6. The apparatus of Aspect 5, wherein the sensor is a time of flight (TOF) sensor or an image sensor.

Aspect 7. The apparatus of any of Aspects 5 or 6, wherein the at least one processor is configured to generate the plurality of first blocks associated with the planar surface within the scene further based on a pose of the sensor and intrinsic parameters of the sensor; and and generate the plurality of second blocks associated with the planar surface within the scene further based on the pose of the sensor and the intrinsic parameters of the sensor.

Aspect 8. The apparatus of any of Aspects 1 to 7, wherein each block of the plurality of first blocks is a voxel.

Aspect 9. The apparatus of Aspect 8, wherein the voxel is a semantic truncated signed distance function (TSDF) volume.

Aspect 10. The apparatus of any of Aspects 1 to 9, wherein the planar surface is a floor, a wall, or a ceiling.

Aspect 11. The apparatus of any of Aspects 1 to 10, wherein the representation of the planar surface is a surface plane equation representing the planar surface as a normal and a point.

Aspect 12. A method for image processing, the method comprising: generating, based on a first depth map corresponding to a scene and a first semantic segmentation map of the scene, a plurality of first blocks associated with a planar surface within the scene; determining, based on the plurality of first blocks, a representation of the planar surface; replacing, based on the representation of the planar surface, first depths for pixels associated with the planar surface in the first depth map with second depths for the pixels associated with the planar surface from a prior depth map corresponding to the scene to generate an updated depth map corresponding to the scene; and generating, based on the updated depth map corresponding to the scene and the first semantic segmentation map of the scene, a plurality of second blocks associated with the planar surface within the scene.

Aspect 13. The method of Aspect 12, further comprising generating, based on a plurality of depth maps corresponding to the scene and a plurality of second semantic segmentation maps of the scene, a plurality of third blocks associated with the planar surface within the scene.

Aspect 14. The method of Aspect 13, further comprising determining, based on an area of the planar surface covered by the plurality of third blocks being greater than an area threshold value, the prior depth map based on the plurality of depth maps.

Aspect 15. The method of any of Aspects 12 to 14, wherein replacing the first depths for the pixels associated with the planar surface in the first depth map with the second depths for the pixels associated with the planar surface from the prior depth map is further based on a difference in the first depths and the second depths being less than a depth threshold value.

Aspect 16. The method of any of Aspects 12 to 15, further comprising generating, by a sensor, the first depth map corresponding to the scene.

Aspect 17. The method of Aspect 16, wherein the sensor is a time of flight (TOF) sensor or an image sensor.

Aspect 18. The method of any of Aspects 16 or 17, wherein generating the plurality of first blocks associated with the planar surface within the scene is further based on a pose of the sensor and intrinsic parameters of the sensor, and wherein generating the plurality of second blocks associated with the planar surface within the scene is further based on the pose of the sensor and the intrinsic parameters of the sensor.

Aspect 19. The method of any of Aspects 12 to 18, wherein each block of the plurality of first blocks is a voxel.

Aspect 20. The method of Aspect 19, wherein the voxel is a semantic truncated signed distance function (TSDF) volume.

Aspect 21. The method of any of Aspects 12 to 20, wherein the planar surface is a floor, a wall, or a ceiling.

Aspect 22. The method of any of Aspects 12 to 21, wherein the representation of the planar surface is a surface plane equation representing the planar surface as a normal and a point.

Aspect 23. A non-transitory computer-readable medium having stored thereon instructions that, when executed by at least one processor, cause the at least one processor to perform operations according to any of Aspects 12 to 22.

Aspect 24. An apparatus for image processing, the apparatus including one or more means for performing operations according to any of Aspects 12 to 22.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
generate, based on a first depth map corresponding to a scene and a first semantic segmentation map of the scene, a plurality of first blocks associated with a planar surface within the scene;
determine, based on the plurality of first blocks, a representation of the planar surface;
replace, based on the representation of the planar surface, first depths for pixels associated with the planar surface in the first depth map with second depths for the pixels associated with the planar surface from a prior depth map corresponding to the scene to generate an updated depth map corresponding to the scene; and
generate, based on the updated depth map corresponding to the scene and the first semantic segmentation map of the scene, a plurality of second blocks associated with the planar surface within the scene.

2. The apparatus of claim 1, wherein the at least one processor is configured to generate, based on a plurality of depth maps corresponding to the scene and a plurality of second semantic segmentation maps of the scene, a plurality of third blocks associated with the planar surface within the scene.

3. The apparatus of claim 2, wherein the at least one processor is configured to determine, based on an area of the planar surface covered by the plurality of third blocks being greater than an area threshold value, the prior depth map based on the plurality of depth maps.

4. The apparatus of claim 1, wherein the at least one processor is configured to replace the first depths for the pixels associated with the planar surface in the first depth map with the second depths for the pixels associated with the planar surface from the prior depth map further based on a difference in the first depths and the second depths being less than a depth threshold value.

5. The apparatus of claim 1, wherein the at least one processor is configured to generate, based on sensor data from a sensor, the first depth map corresponding to the scene.

6. The apparatus of claim 5, wherein the sensor is a time of flight (TOF) sensor or an image sensor.

7. The apparatus of claim 5, wherein the at least one processor is configured to:
generate the plurality of first blocks associated with the planar surface within the scene further based on a pose of the sensor and intrinsic parameters of the sensor; and
generate the plurality of second blocks associated with the planar surface within the scene further based on the pose of the sensor and the intrinsic parameters of the sensor.

8. The apparatus of claim 1, wherein each block of the plurality of first blocks is a voxel.

9. The apparatus of claim 8, wherein the voxel is a semantic truncated signed distance function (TSDF) volume.

10. The apparatus of claim 1, wherein the planar surface is a floor, a wall, or a ceiling.

11. The apparatus of claim 1, wherein the representation of the planar surface is a surface plane equation representing the planar surface as a normal and a point.

12. A method for image processing, the method comprising:
generating, based on a first depth map corresponding to a scene and a first semantic segmentation map of the scene, a plurality of first blocks associated with a planar surface within the scene;
determining, based on the plurality of first blocks, a representation of the planar surface;
replacing, based on the representation of the planar surface, first depths for pixels associated with the planar surface in the first depth map with second depths for the pixels associated with the planar surface from a prior depth map corresponding to the scene to generate an updated depth map corresponding to the scene; and
generating, based on the updated depth map corresponding to the scene and the first semantic segmentation map of the scene, a plurality of second blocks associated with the planar surface within the scene.

13. The method of claim 12, further comprising generating, based on a plurality of depth maps corresponding to the scene and a plurality of second semantic segmentation maps of the scene, a plurality of third blocks associated with the planar surface within the scene.

14. The method of claim 13, further comprising determining, based on an area of the planar surface covered by the plurality of third blocks being greater than an area threshold value, the prior depth map based on the plurality of depth maps.

15. The method of claim 12, wherein replacing the first depths for the pixels associated with the planar surface in the first depth map with the second depths for the pixels associated with the planar surface from the prior depth map is further based on a difference in the first depths and the second depths being less than a depth threshold value.

16. The method of claim 12, further comprising generating, based on sensor data from a sensor, the first depth map corresponding to the scene.

17. The method of claim 16, wherein generating the plurality of first blocks associated with the planar surface within the scene is further based on a pose of the sensor and intrinsic parameters of the sensor, and wherein generating the plurality of second blocks associated with the planar surface within the scene is further based on the pose of the sensor and the intrinsic parameters of the sensor.

18. The method of claim 12, wherein each block of the plurality of first blocks is a voxel.

19. The method of claim 18, wherein the voxel is a semantic truncated signed distance function (TSDF) volume.

20. The method of claim 12, wherein the representation of the planar surface is a surface plane equation representing the planar surface as a normal and a point.
